(19) United States
(12) Patent Application Publication
(10) Pub. No.: US 2016/0005508 A1
(43) Pub. Date: Jan. 7, 2016

(54) CABLE FOR CONVEYING AN ELECTRICAL SUBMERSIBLE PUMP INTO AND OUT OF A WELL BORE

(71) Applicant: ZiLift Holdings, Limited, Aberdeen (GB)

(72) Inventors: Iain Maclean, Aberdeen (GB); Chengcheng Wang, Aberdeen (GB); Kenneth Sears, Aberdeen (GB)

(21) Appl. No.: 14/322,933

(22) Filed: Jul. 3, 2014

(51) Int. Cl. H01B 7/04; H01B 9/00; H01B 3/42; H01B 3/40; H01B 7/17; H01B 3/30

(52) U.S. Cl. CPC H01B 7/046; H01B 7/17; H01B 3/302; H01B 3/427; H01B 3/40; H01B 9/00; H01B 7/04

(57) ABSTRACT

A cable for conveying an electrical submersible pump into and out of a well bore includes at least one strength member made of a composite material comprising a fiber reinforced plastic. A plurality of electrical conductors forming circumferential segments is disposed externally to the at least one strength member. A protective jacket encapsulates the at least one strength member and the plurality of electrical conductors.

### FIELD

This disclosure relates generally to the field of electrical submersible pumps (ESPs) used to lift fluids out of well bores drilled through subsurface formations. More specifically, the disclosure relates to a cable system and method for deploying an ESP into a well bore and through a well bore tubing.

### BACKGROUND

Small diameter ESPs including high power density electric motors and high speed centrifugal pumps have been developed for use in well bores. Such small diameter motors and pumps can be, for example, less than 2.75 in. in diameter, and therefore suitable to be deployed into, for example, a 3.5 in. well bore tubing. These ESPs can have an inverted configuration so that the motor is uphole (closer to the surface end of the well bore) from the pump. In this case, the ESP can be deployed using electrical power cable.

Using conventional cable to deploy such small diameter ESPs would require full-size surface equipment, because the weight of the cable will be excessive, even though the weight of the downhole assembly is much reduced. Conventional steel strength members will also add significantly to the cable weight and therefore increase load requirements of the surface equipment even further. For example, in the case of a pump deployed to 5,000 ft., a typical ESP cable for such a pump is strongly reinforced with high tensile strength steel armoring, as a result of which it weighs about 1,350 lb./kft. (in air). The surface equipment in this case, which consists of a winch, sheaves, and other cable handling equipment, must be capable of a winch pull of 7,400 lb. just to support the weight of the cable and ESP.

Many so-called wireline deployed ESPs use a power cable permanently fixed to the outside of the tubing, which is fitted when the tubing is run in, and use downhole electrical wet connect arrangement to provide electrical power to the pump. This adds cost and complexity, has to be run in as part of the tubing string, and carries an additional risk of unreliability. Further, if the cable needs to be replaced, the tubing has to be retrieved and deployed again using a workover rig.

### SUMMARY

This disclosure relates to a cable for conveying an ESP into and out of a well bore, including through a tubing in the wellbore, without preparation of the tubing. The cable is lightweight and can be deployed using lightweight surface equipment.

In one illustrative embodiment, the cable includes a central strength member made of a fiber reinforced plastic and a plurality of electrical conductors forming circumferential segments disposed externally to the central strength member. A protective jacket encapsulates the central strength member and plurality of electrical conductors.

It is to be understood that both the foregoing summary and the following detailed description are exemplary. The accompanying drawings are included to provide a further understanding of this disclosure and are incorporated in and constitute a part of this disclosure.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a cable attached to an ESP.

FIG. 2 shows a cross-section of the cable of FIG. 1 according to one illustrative embodiment.

FIG. 3 shows a cross-section of the cable of FIG. 1 according to another illustrative embodiment.

FIG. 4 shows a conductor with a hollow cross-section.

FIG. 5 shows a conductor made of a plurality of thin wires.

### DETAILED DESCRIPTION

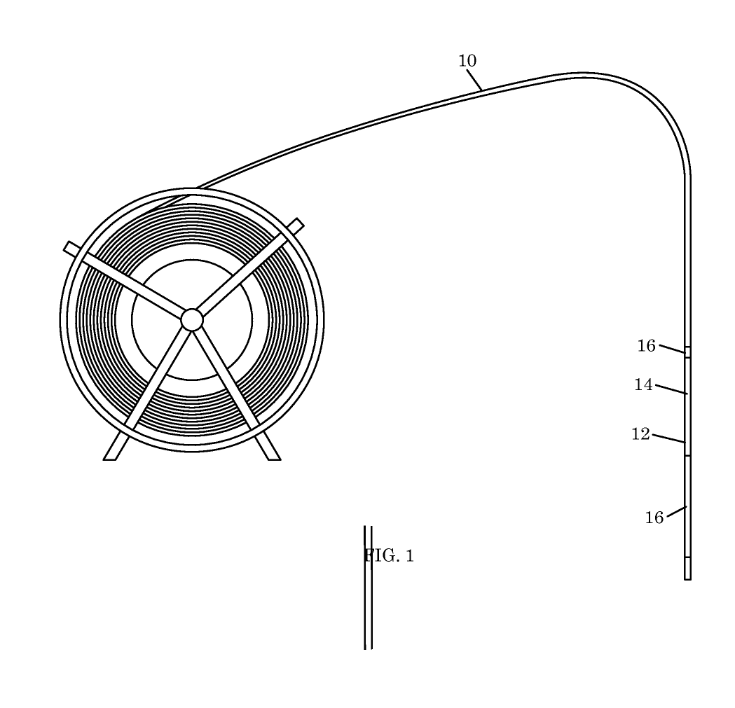

FIG. 1 shows a cable 10 attached to an electrical submersible pump (ESP) 12. The ESP includes at least a motor 14 and a pump 16 and may have other parts not specifically identified but known in the art, such as a protector (not shown separately). The cable 10 is designed for deploying the ESP 12 into a well bore, and retrieving the ESP 12 from the wellbore, and for powering the motor 14 of the ESP 12. In one embodiment, the ESP 12 is a small diameter ESP that is sized for conveyance through a tubing (not shown) in the well bore. In one embodiment, the cable 10 has a corresponding small diameter to enable it to pass through the tubing in the well bore while attached to the ESP 12. In one embodiment, the cable 10 is used to supply three phase alternating current (AC) electrical power to the motor 14 of the ESP 12. In one embodiment, the cable 10 is designed to be lightweight but strong enough to support the weight of the ESP 12 at any desired depth in the well bore. In one embodiment, the cable 10 is designed to be flexible such that it may be wound on a reel and extended from the reel as needed to deploy the ESP 12 into the well bore. The end of the cable 10 attached to the ESP 12 may include a suitable adapter 16 for electrically coupling the cable 10 to the motor 14 of the ESP 12.

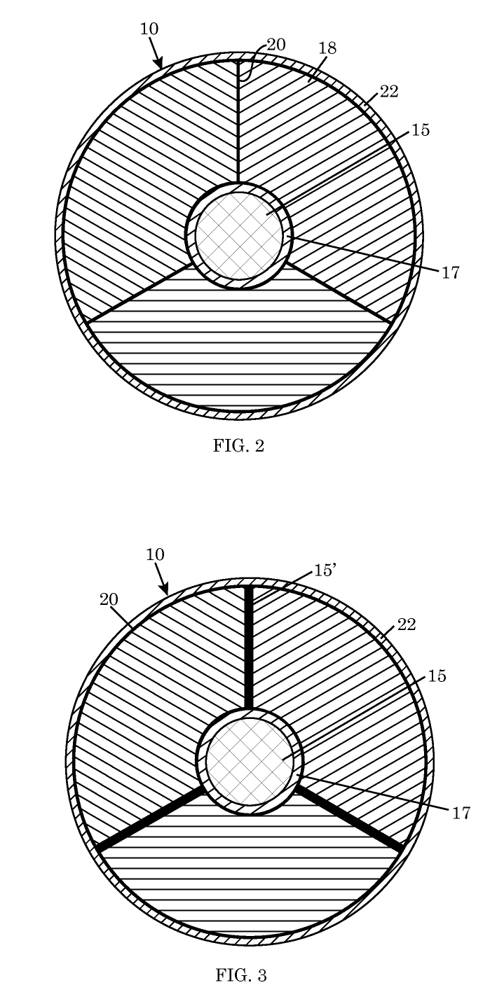

FIG. 2 shows an example cross-section of one embodiment of the cable 10. The cable 10 in FIG. 2 may have a substantially circular cross-section to enable passage of the cable 10 through certain types of well pressure control equipment (not shown) disposed at the upper end of the well bore. In FIG. 2, the cable 10 includes a central strength member 15 made of a composite material. The composite material may in one embodiment be a plastic matrix reinforced with elongate, high modulus fibers, i.e., a fiber reinforced plastic. In one example, the high modulus fibers may be carbon fibers. In one embodiment, the matrix material may be a thermosetting resin or thermoplastic. In one embodiment, the matrix material is selected from polyurethane, polystyrene, polyethylene, epoxy, and any combinations of these materials. The use of composite material for the central strength member 15, as described above, may allow a strong, flexible, and lightweight cable 10. The diameter of the composite central strength member 15 can be selected to reduce the overall weight of the cable 10 in liquid for a selected cable tensile capacity. In one embodiment, the fibers in the composite material central strength member 15 may be predominantly oriented at an angle of less than 60 degrees to an axial or longitudinal axis of the cable 10. In one embodiment, a layer of high temperature elastomer 17, such as rubber or flexible polyurethane, may be applied around the central strength member 15 to form a pressure seal around the composite material central strength member 15.

The cable 10 may further include electrical conductors 18 shaped in the form of circumferential segments, arranged around the central strength member 15. In one embodiment, the central strength member 15 has a round cross-section, and the segments of conductors 18 are shaped to form an annular cylindrical cross-section around the substantially the entire circumference of the central strength member 15, e.g., other than the thickness of insulation to be described below.

The conductors 18 may be encapsulated in insulation 20, such as may be made from polypropylene, neoprene, TEFLON brand plastic, or other material known in the art for insulating electrical conductors exposed to high ambient temperature and hydrostatic pressure. TEFLON is a registered trademark of E.I. du Point de Nemours and Company, Wilmington, Del. The insulation 20 may separate the conductors 18 from the central strength member 15 on their radial innermost surfaces and from each other on circumferentially adjacent surfaces. In one embodiment, the insulation 20 may be a plastic such as polyamides, polytetrafluoroethylene (PTFE), polyether ether ketone (PEEK), polyurethane or a compound containing or based on any of these materials. In another embodiment, the insulation may be an elastomer. In yet another embodiment, the insulation material may be enamel. In other embodiments, the insulation 20 may be high temperature resistant rubber, neoprene, flexible polyurethane or any other material known in the art to be used as electrical insulation for flexible electrical conductors in cables. The insulation 20 may be provided as one or more layers of coating on a surface of the conductors or as a sheath encapsulating the conductors. The present example embodiment of the cable 10 includes a protective jacket 22 surrounding the conductors 18 and encapsulating both the conductors 18 and central strength member 15.

In another embodiment, as shown in FIG. 3, radial strength members 15′ in the form of flat strips may be placed between the conductors 18. The radial strength members 15′ can be made of the same material as the central strength member 15 and extend laterally from an outer surface thereof. The cable construction using the radial strength members 15′ will be more resistant with respect to bending than the cable construction using only the central strength member 15 because the composite material is disposed at a greater radius from the center of the cable. The cable construction using the radial strength members 15′ may be advantageous for certain operational conditions where maximum bending flexibility (i.e. minimized bending radius) is not required but additional resistance to bucking of the cable 10 is desirable.

In the example shown in FIG. 2, the cable 10 has three substantially equal cross sectional area conductors 18 covering substantially the entire circumference of the central strength member 15 for use with a three phase AC electrical power supply. As is well known in the art, in three phase power supply systems, three conductors each carry an alternating current of substantially the same magnitude, but the phase of the voltage on each conductor is displaced from each of the other conductors by 120 degrees. In some embodiments, the cross-sectional area of the three conductors may be different from each other. For example, if the motor used with the ESP is a split-phase, capacitor start/run motor operated from single phase AC, only two power carrying conductors may cover substantially the entire circumference and/or may include a much smaller cross section conductor (i.e., one that traverses a much smaller circumferential section, e.g., ten degrees) for control signal and/or data transmission may be used in conjunction with the two power carrying conductors.

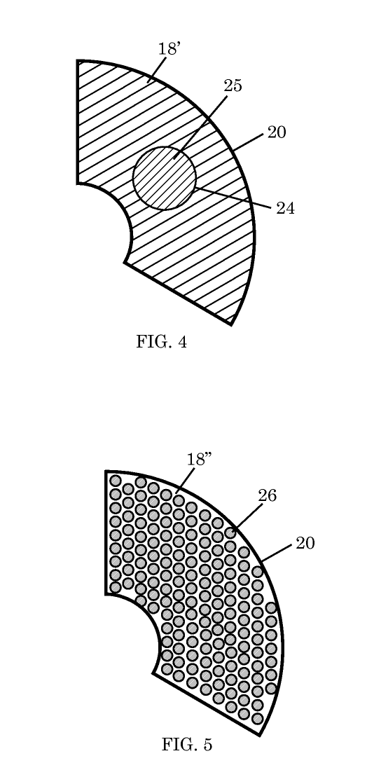

As is known in the art, in some embodiments the AC frequency may be varied to control the speed of the motor (14 in FIG. 1) coupled to the pump (16 in FIG. 1). The conductors 18 may be made of metal, typically copper or aluminum. The conductors 18 may have a solid cross-section as shown in FIG. 2. FIG. 4 shows another embodiment of a conductor 18′ that may be used in an example embodiment of the cable such as the embodiment shown in FIG. 2. The present embodiment of the conductor 18′ may have a hole 24 with a selected diameter, i.e., a hollow centered cross-section. The hole 24 may be in the geometric center of the conductor 18′ in some embodiments. The conductor 18′ may have more than one hole 24, and the cross-section of the hole 24 is not limited to a round cross-section as shown in FIG. 4. In some embodiments, the hole 24 may be shaped similarly to the external shape of the conductor 18′ so that a thickness of the conductor 18′ from its exterior wall to the edge of the hole 24 is substantially constant. The hole 24 may be used in high electrical conductivity material conductors such as copper, where the skin effect at selected AC frequencies is such that having no electrically conductive material in the center of the conductor 18′ will not substantially affect the conductivity (or its inverse, impedance per unit length) of the conductor 18′. A cross sectional area of the hole 24 may be selected such that impedance of the conductor 18′ per unit length increases by a maximum selected amount for a selected AC frequency. In one embodiment, the cross sectional area of the hole 24 may be selected such that the impedance per unit length of the conductor increases by at most five percent, and more preferably by at most one percent above the impedance of a full cross section conductor (18 in FIG. 2) at a selected AC frequency.

FIG. 5 shows another example of a conductor 18″ that may be used in a cable as shown in FIG. 2. The present example embodiment of the conductor 18″ includes a plurality of small diameter, electrically conductive wire strands 26 that together comprise a conductor similar in cross-sectional area and shape to the conductor 18 shown in FIG. 2. The strands 26 may be made from, for example, copper or aluminum as the solid conductor 18 explained with reference to FIG. 2. The conductor 18″ will generally be more flexible (i.e. have a smaller resistance to bending) than the solid conductor shown at 18 in FIG. 2.

The material and cross-sectional area of the conductors 18, 18′, and the hole 24 if used, may be selected to achieve the desired effective conductivity of the cable 10 at a selected alternating current frequency. The conductor 18″ in FIG. 5 in some embodiments may have a hole and filler material substantially as explained with reference to FIG. 4.

Hollow cross-section conductors, such as conductor 18′ shown in FIG. 4, may be used to reduce the overall weight of the cable 10 in liquid when a higher density material such as copper is used for the conductors. To reduce the possibility of collapsing the hole 24 in the conductor under bending stress, a filler material shown at 25 in FIG. 4 may be disposed in the hole 24. The filler material 25 may be, e.g., a low density plastic, such as low density polyethylene (LDPE), or a fiber reinforced plastic. Irrespective of the material used as a filler material to fill the hole 24, such material should have a density lower than the material from which the electrical conductor 18′ is made. As explained above, the cross-sectional area of the hole 24 may be selected such that conductivity (or its inverse, impedance per unit length) of the hollow cross-section conductor 18′ is substantially the same, or changes at most by a selected amount as that of the solid cross-section conductor 18 in FIG. 2 at a selected alternating current frequency. The holes 24 will reduce the weight of the cable 10 in liquid but if sized as explained above will not substantially reduce the effective conductivity of the cable 10.

Solid cross-section conductors, such as conductor 18 in FIG. 2, together with lower density electrical conductor material may be used to reduce the overall weight of the cable 10 in liquid. For example, in some embodiments aluminum conductors of cross-sectional area selected to provide equal conductivity (or its inverse, impedance per unit length) to an equivalent cross-sectional area of copper conductors at a selected alternating current frequency. By using aluminum it may be possible to reduce the weight of the cable in liquid to a selected value, while providing an equivalent electrical conductivity and current carrying capacity as copper conductors. Aluminum conductors may be solid cross-section and thereby omit the holes (24 in FIG. 4), but the additional cross-section needed for aluminum conductors is not more than that needed for copper conductors to carry the same current (or, conversely have the same impedance per unit length) as copper conductors. Also, the much lower density of aluminum compared to copper would reduce the weight of the cable in liquid notwithstanding the necessary increased cross-sectional area of the conductors when made from aluminum.

The protective jacket 22 may have a smooth (or slick) outer surface to enable effective sealing at a wellhead. The protective jacket 22 may also provide protection to the insulation on and to the conductors 18 (18′) from abrasion and other wear. The protective jacket 22 may have a low friction for spooling the cable 10 into and out of the well bore. The protective jacket 22 may be made of one or more layers of material having the properties described above. In one embodiment, the protective jacket 22 is made of plastic. In one example, the plastic may be polyurethane, polyamides, polypropylene, PEEK, or a compound containing or based on any of the foregoing materials. In some embodiment, the jacket 22 may include woven fiber braid (not shown) embedded in the plastic to enhance strength and abrasion resistance. The fiber braid may be made from an electrically non-conductive material such as ARAMID brand fiber, glass fiber or KEVLAR brand fiber to prevent power loss by induction of eddy currents in the braid as alternating current flows through the electrical conductors (18, 18′, 18″).

One method for manufacturing the cable includes forming the central strength member (15 in FIGS. 2) by fiber pultrusion, followed by fully curing the plastic material (e.g., thermosetting resin or thermoplastic). A layer of high temperature elastomer (17 in FIG. 2) may then be applied around the central strength member by wrapping or by an extrusion process. Each conductor (e.g., 18 in FIG. 2) can be formed in circumferentially segmented cross-section, with space to accommodate the central strength member. The conductors may be encapsulated in a layer of insulation material (e.g., plastic, elastomer, or enamel). Then, the insulated conductors are arranged around the elastomer-sealed central strength member. A jacket (e.g., 22 in FIG. 2) may then be extruded onto the outer diameter of the cable. A coating of a selected material may be applied on the jacket. In some embodiments, the coating and/or jacket may include woven fiber braid, such as may be made from glass fiber or synthetic fiber such as ARAMID brand fiber or KEVLAR brand fiber. KEVLAR is a registered trademark of E.I. du Pont de Nemours and Company, Wilmington, Del. In some embodiments, the jacket 22 may include steel or other metallic elements for the purpose of enhancing abrasion resistance of the jacket 22, thus providing enhanced protection for the electrical conductors (18, 28′, 18″).

The use of composite materials allows a stronger and lighter cable. An example cable includes three conductors, each having a cross-sectional area of 0.0206 in² (6 AWG) and a 0.25-in diameter central strength member made of a composite material with a tensile strength of 200,000 lb/in², which provides a tensile capacity of 10,000 lb. The diameter over the conductors is very close to the standard electrical “wireline” cable diameter of 17/32 in. “Wireline” is a cable used to move well logging instruments along the interior of a well bore for measurement and well intervention operations as will be familiar to those skilled in the art.

A cable as described herein uses composite material to combine tensile strength with low weight per unit length. The cable may have electrical current capacity equivalent to higher weight per unit length cables of known configurations for use with ESPs. The cable according to the present disclosure has a small cross section, e.g., small enough to pass through a well bore tubing. The cable in some embodiments has a slick surface and is flexible for spooling. The foregoing properties may allow the cable according to the present disclosure to be suitable for use in deploying a complete ESP system into a well bore, through tubing, using lightweight surface equipment, for example, a standard wireline winch and spooler, without prior preparation of the tubing. The ESP system can be retrieved through the tubing, including all electrical requirements, leaving the well bore free for interventions, sand clearing, etc. All parts of the ESP system can be retrieved for repair, overhaul, or replacement.

The cable described herein may have advantages compared to conventional composite cable constructions in which the strength members are predominantly on the outer diameter for applications where flexibility is advantageous. First, for small diameter needs, the cable construction described herein may have tensile strength and conductor cross-sectional area in a smaller diameter overall cable than conventional composite cable constructions. Secondly, the cable construction described herein may be more flexible for spooling in relation to its tensile strength than a conventional construction cable.

The lightweight of the cable, as described herein, combined with its tensile stiffness means that cable stretch is reduced.

For the embodiment using a composite central strength member, the high specific strength of the composite central strength member provides a very lightweight cable that does not require additional strength members to meet the line pull requirements. The lightweight cable means that the weight of the cable in the liquid in the well bore is not significant and the line pull is available for mechanical pull operations (unsetting packers, etc.)

The small cross section and slick surface of the cable also minimize interference with the produced flow up the tubing in which the cable is installed.

The conductors of the cable can advantageously be segmental cross-section within the cable, which increases the conductor packing factor and minimizes the cross-sectional area.

The cable uses materials that can withstand the high temperatures required for the manufacture of carbon fiber composites.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A cable for conveying an electrical submersible pump into and out of a well bore, comprising:
at least one strength member made of a composite material comprising a fiber reinforced plastic;
a plurality of electrical conductors forming circumferential segments disposed externally to the at least one strength member; and
a protective jacket encapsulating the at least one strength member and the plurality of electrical conductors.

2. The cable of claim 1, wherein the plurality of electrical conductors comprises three electrical conductors.

3. The cable of claim 1, wherein the plurality of electrical conductors each comprises a solid cross-section.

4. The cable of claim 3, wherein the plurality of electrical conductors each comprises a hollow cross-section.

5. The cable of claim 4, wherein the hollow cross section comprises a hole in the electrical conductor.

6. The cable of claim 4, wherein a cross sectional area of the hole is selected to increase the impedance per unit length of the electrical conductor by at most a selected amount.

7. The cable of claim 6, wherein the selected amount is at most five percent.

8. The cable of claim 6, wherein the selected amount is at most one percent.

9. The cable of claim 4, wherein the hole is filled with an electrically non-conductive material having a density lower than a density of the electrical conductor.

10. The cable of claim 1, wherein the projective jacket has a smooth outer surface.

11. The cable of claim 1, wherein fibers in the fiber reinforced plastic are oriented at an angle of at most 60 degrees with respect to a longitudinal axis of the cable.

12. The cable of claim 1, wherein fibers in the fiber reinforced plastic comprise carbon fibers.

13. The cable of claim 12, wherein the fiber reinforced plastic comprises at least one of polyurethane, polystyrene, polyethylene, epoxy, and any combination thereof.

14. The cable of claim 1, wherein the electrical conductors are encapsulated in insulation.

15. The cable of claim 14, wherein the insulation comprises at least one of polytetrafluoroethylene, polyether ether ketone, polyurethane, and combinations thereof.

16. The cable of claim 14, wherein the insulation comprises an elastomeric material.

17. The cable of claim 14, wherein the insulation comprises an enamel.

18. The cable of claim 1, wherein the projective jacket comprises at least one of polyurethane, polyamides, polypropylene, polyether ether ketone, and combinations thereof.

19. The cable of claim 1, wherein the at least one strength member is located at a center of the cable.

20. The cable of claim 19, further comprising additional strength members disposed between adjacent ones of the plurality of electrical conductors.

21. The cable of claim 1, wherein an external diameter of the cable is selected to enable passage thereof through a well bore tubing.

22. The cable of claim 21, wherein an electrical submersible pump is attached to an end of the cable, the electrical submersible pump having a diameter selected to enable passage through the well bore tubing.
